(19) United States
(12) Patent Application Publication
(10) Pub. No.: US 2006/0074528 A1
(43) Pub. Date: Apr. 6, 2006

(54) Self-propelled cleaner

(75) Inventor: Naoya Uehigashi, Osaka (JP)

Correspondence Address: YOKOI & CO. U.S.A., INC., 13700 MARINA POINTE DRIVE #723, MARINA DEL RAY, CA, 90292, US

(73) Assignee: Funai Electric Co., Ltd., Osaka (JP)

(21) Appl. No.: 11/229,945

(22) Filed: Sep. 19, 2005

(30) Foreign Application Priority Data
Sep. 29, 2004 (JP) JP2004-283404

(51) Int. Cl. G06F 19/00

(52) U.S. Cl. 700/258; 700/245

(57) ABSTRACT

Disclosed is a self-propelled cleaner making it possible to reduce a cost by decreasing the number of components through multipurpose use of one sensor. When ultrasonic sensors sense a forward wall, the direction of movement in which a body is moved is corrected based on the distances to the wall measured by two ultrasonic sensors so that the direction of movement will be perpendicular to the wall. Thereafter, an azimuth indicated by a gyro-sensor is reset with a direction perpendicular to the wall regarded as a reference direction. The ultrasonic sensors designed to prevent collision with the forward wall may be used as sensors for compensating an error caused by the gyro-sensor. Consequently, the number of components is decreased, and a cost of manufacture is reduced.

### BACKGROUND OF THE INVENTION

1. Field of the Invention

The present invention relates to a self-propelled cleaner including a body that has a cleaner mechanism, and a drive mechanism responsible for steering and driving.

2. Description of the Related Art

In the past, self-propelled cleaners including a gyro-sensor that detects an azimuth in which a cleaner body is oriented have been known (refer to, for example, Japanese Unexamined Patent Publications Nos. 2004-21894, 62-14212, and 57-187712). The self-propelled cleaner can be traveled while being controlled so that a direction of movement will remain constant all the time.

Moreover, Japanese Unexamined Patent Publication No. 10-240343 has disclosed a self-propelled cleaner that includes a gyro-sensor and a sensor that verifies whether the self-propelled cleaner is traveling in parallel with a wall, and that appropriately corrects an azimuth of a body indicated by the gyro-sensor according to the result of verification performed by the sensor. The self-propelled cleaner can appropriately compensate an error caused by the gyro-sensor due to a so-called drift phenomenon or the like. Consequently, the self-propelled cleaner can travel stably with a little deviation from a designated route.

However, the self-propelled cleaner described in the Japanese Unexamined Patent Publication No. 10-240343 requires a sensor exclusively for compensation of an error in an azimuth indicated by the gyro-sensor. This poses a problem in that a cost may increase in the future.

### SUMMARY OF THE INVENTION

The present invention addresses the foregoing problems. An object of the present invention is to provide a self-propelled cleaner making it possible to reduce a cost by decreasing the number of components through multipurpose use of one sensor.

In order to accomplish the foregoing object, the present invention provides a self-propelled cleaner including a body that has a cleaner mechanism, a drive mechanism responsible for steering and driving, and an angular velocity sensor, an angle detector that detects an azimuth, in which the body is oriented, by integrating a sensor output value provided by the angular velocity sensor, and a plurality of distance meters each of which measures the distance of the body to a wall located in a direction of movement in which the body is moved.

The self-propelled cleaner includes a reset processor that controls the drive mechanism on the basis of the values of the distance to the wall measured by at least two distance meters so that the direction of movement of the body will meet the wall at a predetermined angle.

When the direction of movement of the body meets the wall at the predetermined angle, the reset processor halts the body. Thereafter, the reset processor resets the total value of the sensor output value integrated by the angle detector.

According to the present invention having the foregoing features, a self-propelled cleaner includes a body that has a cleaner mechanism, a drive mechanism responsible for steering and driving, an angular velocity sensor, an angle detector that detects an azimuth, in which the body is oriented, by integrating a sensor output value provided by the angular velocity sensor, and a plurality of distance meters each of which measures the distance of the body to a wall located in the direction of movement in which the body is moved. The distance meter functions as a sensor that prevents collision with the wall. Consequently, collision with the wall can be avoided.

Moreover, the self-propelled cleaner includes a reset processor that controls the drive mechanism on the basis of the values of the distance to the wall measured by at least two distance meters among the plurality of distance meters so that the direction of movement of the body will meet the wall at a predetermined angle. When the direction of movement has come to meet the wall at the predetermined angle, the reset processor halts the body and then resets the total value of a sensor output value integrated by the angle detector. Consequently, the sensor for preventing collision can be used as a sensor that compensates an error caused by the angle detector, such as, a gyro-sensor. Eventually, the number of components is decreased and a cost of manufacture is reduced.

As for the cleaner mechanism included in the body, a cleaner mechanism of a suction type, a type of cleaner mechanism that uses a brush to gather dirt, or a combination of both types of cleaner mechanisms may be adopted. Moreover, the drive mechanism capable of steering and driving the body controls rotations of drive wheels, which are disposed on the right and left sides of the body, independently of each other, and thus changes the directions of movement of the body so as to advance or withdraw the self-propelled cleaner or turn the body right or left, or swivel the body in the same place. Needless to say, front and rear auxiliary wheels may be included. Moreover, the role of the drive wheels may not be filled by wheels but may be filled by an endless belt. Otherwise, the drive mechanism can be realized with four wheels, six wheels, or any other various constructions. Moreover, a gyro-sensor may be adopted as the angle detector included in the self-propelled cleaner in accordance with the present invention. However, the present invention is not limited to any specific type of gyro-sensor. For example, a gas rate gyro-sensor, a vibratory gyro-sensor, or the like may be adopted.

In another aspect of the present invention, the reset processor controls the drive mechanism on the basis of the values of the distance to the wall measured by at least two distance meters so that the direction of movement of the body will be perpendicular to the wall.

When the direction of movement becomes perpendicular to the wall, the reset processor halts the body. Thereafter, the reset processor resets the total value of a sensor output value integrated by the angle detector.

According to the present invention having the foregoing features, when the direction of movement of the body becomes perpendicular to the wall, the body is halted. Thereafter, the total value of a sensor output value integrated by the angle detector is reset. A deviation (error) of the direction of movement of the body, which is indicated by the gyro-sensor, from a perpendicular direction in which the body is moved can be compensated.

In another aspect of the present invention, the reset processor invalidates control of a driving force which the drive mechanism exerts according to an azimuth detected by the angle detector. The reset processor controls the drive mechanism on the basis of the values of the distance to the wall measured by at least two distance meters so that the self-propelled cleaner will travel towards the wall and the direction of movement of the body will become perpendicular to the wall. When the direction of movement of the body becomes perpendicular to the wall, the reset processor halts the body, and resets the total value of a sensor output value integrated by the angle detector. Thereafter, the reset processor validates the control of a driving force which the drive mechanism exerts according to an azimuth detected by the angle detector.

According to the present invention having the foregoing features, a sensor that prevents collision is used as a sensor that compensates an error caused by an angle detector such as a gyro-sensor. Consequently, the number of components is decreased and a cost of manufacture is reduced.

Moreover, in another aspect of the present invention, the distance meter is realized with an ultrasonic sensor.

According to the present invention having the foregoing feature, the ultrasonic sensor has a simple structure and is inexpensive. This contributes to a reduction in a cost of manufacture.

Moreover, in another aspect of the present invention, the reset processor resets the total value of an integrated sensor output value every time the wall enters a range of distance measurement covered by the distance meters.

According to the present invention having the foregoing feature, every time the body approaches a wall, an error caused by the angle detector can be compensated. Consequently, the self-propelled cleaner can travel stably with a little deviation from a designated route.

Moreover, in another aspect of the present invention, the reset processor resets the total value of an integrated sensor output value at regular intervals.

According to the present invention having the foregoing feature, since an error caused by the angle detector can be compensated at regular intervals, the self-propelled cleaner can travel stably all the time.

Moreover, in another aspect of the present invention, the reset processor resets the total value of an integrated sensor output value responsively to a user's entry of an instruction.

According to the present invention having the foregoing feature, an error caused by the angle detector can be compensated according to a user's desired timing.

### BRIEF DESCRIPTION OF THE DRAWINGS

FIG. 1 is a perspective view showing the appearance of a self-propelled cleaner in accordance with the present invention;

FIG. 2 is a bottom view of the self-propelled cleaner shown in FIG. 2;

FIG. 3 is a block diagram showing the configuration of the self-propelled cleaner shown in FIG. 1 and FIG. 2;

FIG. 4 is a flowchart describing the flow of a main process;

FIG. 5 is a flowchart describing the flow of an automatic cleaning mode to be invoked and executed at step S120 in the flow described in FIG. 4;

FIG. 6 illustratively shows an example of a travel route to be traced by the self-propelled cleaner when the automatic cleaning mode described in FIG. 5 is executed;

FIG. 7 is a flowchart describing the flow of gyro-sensor resetting to be invoked and executed at step S220 in the flow described in FIG. 5; and

FIG. 8 illustratively shows a scene where the direction of movement of a body is adjusted while ultrasonic sensors are measuring distances.

### DESCRIPTION OF THE PREFERRED EMBODIMENTS

An embodiment of the present invention will be described in relation to each of the following items:

(1) Appearance of a self-propelled cleaner

(2) Internal configuration of the self-propelled cleaner

(3) Actions to be performed in the self-propelled cleaner

(4) Various variants

(1) Appearance of a Self-propelled Cleaner

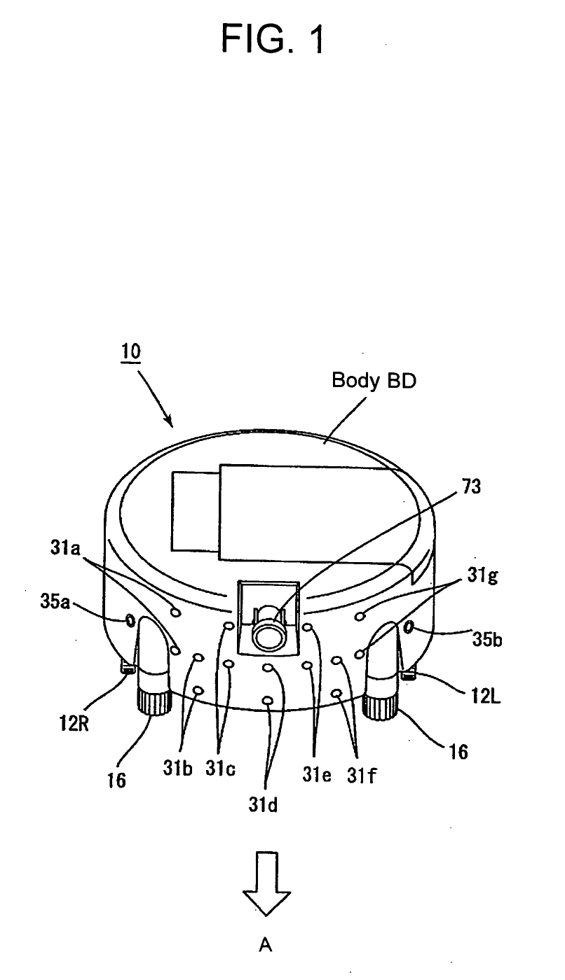

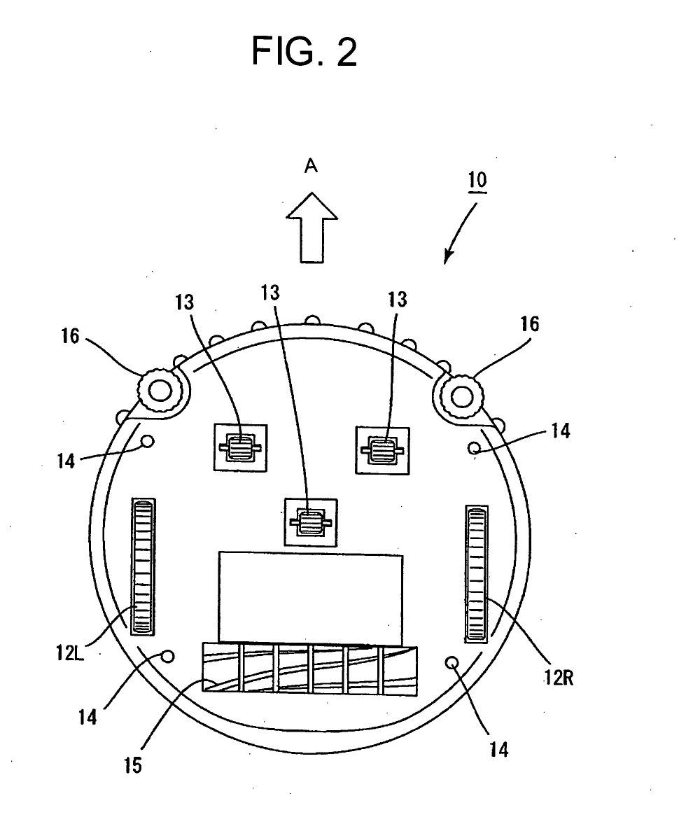

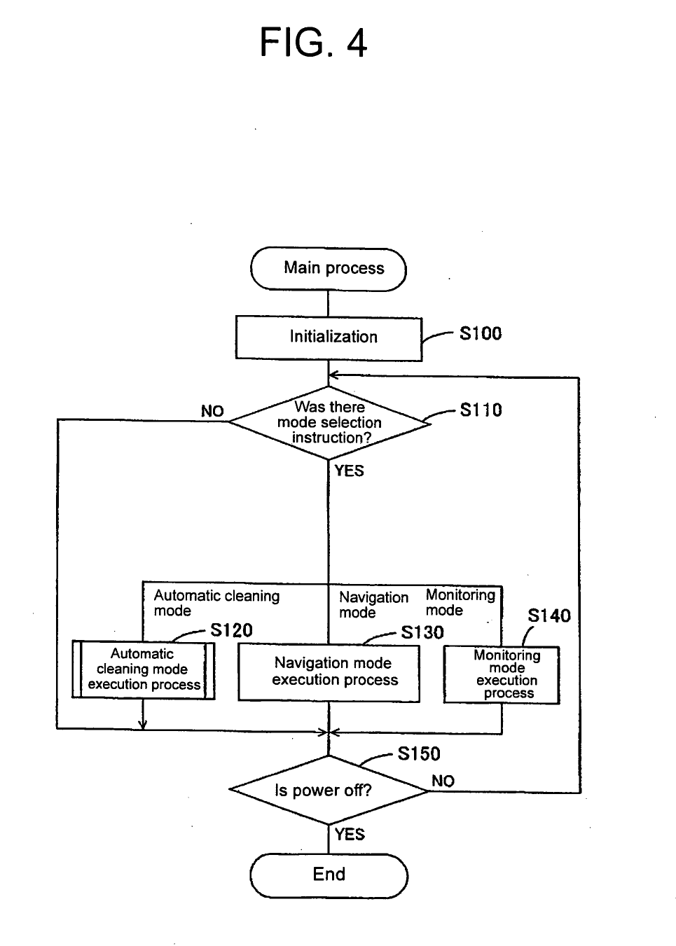

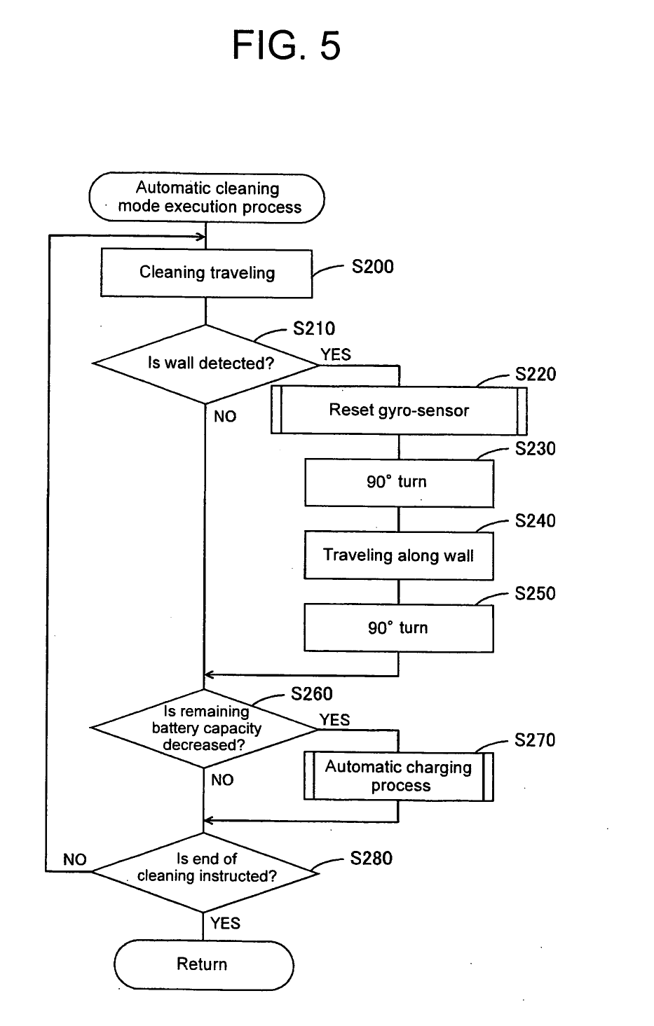

FIG. 1 is a perspective view showing the appearance of a self-propelled cleaner in accordance with the present invention, and FIG. 2 is a bottom view of the self-propelled cleaner shown in FIG. 1. In FIG. 1, a direction indicated with an arrow A is a direction of movement in which the self-propelled cleaner moves. As shown in FIG. 1, the self-propelled cleaner 10 in accordance with the present invention has a substantially cylindrical body BD. Two drive wheels 12R and 12L (see FIG. 2) located on the bottom of the body BD are driven independently of each other, whereby the self-propelled cleaner can advance rectilinearly, withdraw, or turn. Moreover, an infrared CCD sensor 73 serving as an imaging sensor is located in the center of the face of the body BD. The infrared CCD sensor 73 is of a movable type and can image a scene spreading in front of the face of the body BD. Moreover, the infrared CCD sensor 73 can image the inside of an incorporated dust box 90 (not shown) as described later in conjunction with FIG. 4 and FIG. 5.

Moreover, seven ultrasonic sensors 31 (31a to 31g) serving as distance meters are located below the infrared CCD sensor 73. The ultrasonic sensors 31 each include a generator that generates ultrasonic waves and a receiver that receives ultrasonic waves generated by the generator and reflected from a forward wall. The ultrasonic sensors 31 calculate a distance to the wall on the basis of times elapsing until the respective receivers receive ultrasonic waves generated by the generators. Among the seven ultrasonic sensors 31, an ultrasonic sensor 31d is located in the center of the face of the body BD. An ultrasonic sensor 31a and an ultrasonic sensor 31g, an ultrasonic sensor 31b and an ultrasonic sensor 31f, and an ultrasonic sensor 31c and an ultrasonic sensor 31e are disposed laterally symmetrically. When the direction of movement in which the body BD is moved is perpendicular to the forward wall, the distances measured by the ultrasonic sensors 31 disposed laterally symmetrically are equal to each other.

Moreover, pyroelectric sensors 35 (35a and 35b) serving as human body sensors are located on the right and left sides of the face of the body BD. The pyroelectric sensors 35a and 35b detect infrared rays generated by a human body and thus sense a human being lying near the body BD. The pyroelectric sensors 35 (35c and 35d) are located on the right and left sides of the back of the body BD, though they are not shown in FIG. 1. Thus, a range of 360° around the body BD is a detectable range.

Referring to FIG. 2, the two drive wheels 12R and 12L are located at the right and left ends of the center part of the bottom of the body BD. Moreover, three auxiliary wheels 13 are disposed on the front side of the bottom of the body BD (in the direction of movement). Furthermore, a step sensor 14 that senses irregularities on a floor surface or a step is disposed at each of the upper right end, lower right end, upper left end, and lower left end of the bottom of the body BD. A main brush 15 is located on the rear side of the bottom of the body BD. The main brush 15 is driven to rotate by a main brush motor 52 (not shown) and thus gathers dust and dirt on a floor surface. Moreover, an opening through which the main brush 15 is exposed serves as a suction port. While the main brush 15 is gathering dust and dirt, the gathered dust and dirt are sucked through the suction port. Moreover, a side brush 16 is disposed at each of the right and left upper ends of the bottom of the body BD.

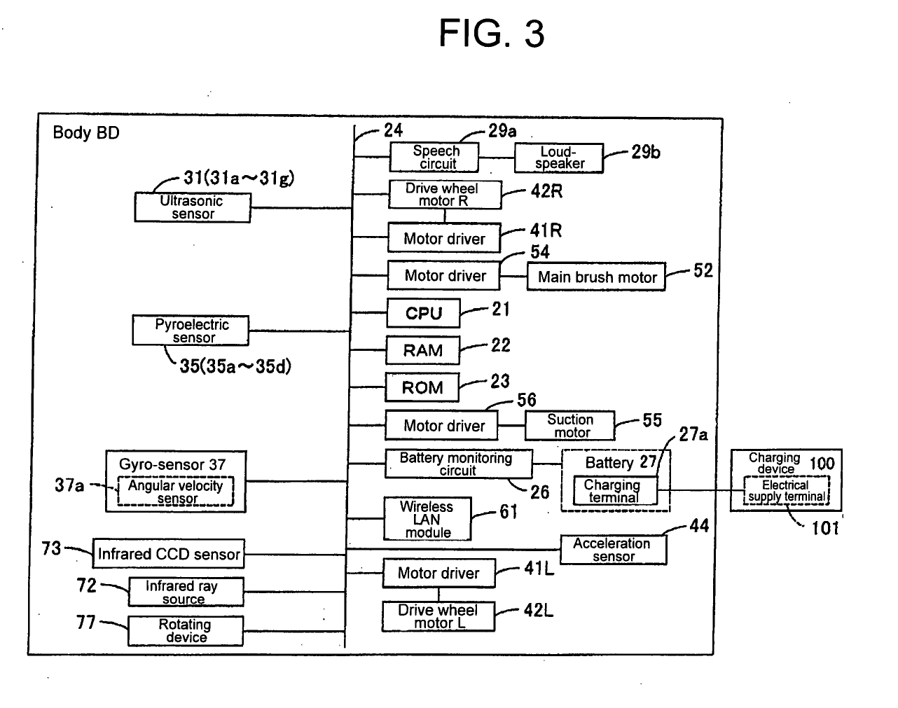

Incidentally, the self-propelled cleaner 10 in accordance with the present invention includes, aside from the ultrasonic sensors 31, pyroelectric sensors 35, and step sensors 14, various kinds of sensors that will be described later in conjunction with a drawing (FIG. 3).

(2) Internal Configuration of the Self-propelled Cleaner

FIG. 3 is a block diagram showing the configuration of the self-propelled cleaner shown in FIG. 1 and FIG. 2. As shown in FIG. 3, in the body BD, a CPU 21 serving as a control unit, a ROM 23, and a RAM 22 are interconnected over a bus 24. The CPU 21 implements various controls using the RAM 22 as a work area according to control programs and various parameter tables stored in the ROM 23.

The body BD includes a battery 27. The CPU 21 can monitor the remaining battery capacity of the battery 27 using a battery monitoring circuit 26. The battery 27 includes a charging terminal 27a via which the body is charged via a charging device 100 that will be described later. An electrical supply terminal 101 included in the charging device 100 is coupled to the charging terminal 27a, whereby the body is charged. The battery monitoring circuit 26 monitors a voltage at the battery 27 so as to sense the remaining battery capacity. Moreover, the body BD includes a speech circuit 29a connected on the bus 4. A loudspeaker 29b radiates sounds according to an audio signal produced by the speech circuit 29a.

The body BD includes the ultrasonic sensors 31 (31a to 31g) serving as distance meters, the pyroelectric sensors 35 (35a to 35d) serving as human body sensors, and the step sensors 14 (see FIG. 1 and FIG. 2). Moreover, the body BD includes a gyro-sensor 37 that is a sensor not shown in FIG. 1 and FIG. 2. The gyro-sensor 37 includes an angular velocity sensor 37a that detects an angular velocity that is a rate at which the direction of movement of the body BD changes. A sensor output value provided by the angular velocity sensor 37a is integrated in order to detect an azimuth in which the body BD is oriented.

The self-propelled cleaner 10 in accordance with the present invention includes as a drive mechanism motor drivers 41R and 41L, drive wheel motors 42R and 42L, and gear units, which are not shown, interposed between the drive wheel motors 42R and 42L and the drive wheels 12R and 12L. For turning the body, the motor drivers 41R and 41L finely control a direction of rotation and an angle of rotation so as to drive the drive wheel motors 42R and 42L respectively. The motor drivers 41R and 41L each transmit a driving signal in response to a control instruction sent from the CPU 21. Any gear unit and any drive wheel can be adopted as the gear units and the drive wheels 12R and 12L. Moreover, circular rubber tires may be driven or an endless belt may be driven.

Moreover, the actual directions and angles of rotation of the drive wheels can be accurately sensed based on outputs of rotary encoders (not shown) included as integral parts of the drive wheel motors 42R and 42L respectively. Incidentally, the rotary encoders may not directly be coupled to the drive wheels, but driven wheels capable of freely rotating may be disposed near the drive wheels. Magnitudes of rotations made by the driven wheels may be fed back in order to sense actual magnitudes of rotations even in case the drive wheels skid. Moreover, an acceleration sensor 44 senses accelerations occurring in directions of three axes X, Y, and Z, and transmits the results of sensing. Any gear unit and any drive wheel can be adopted as the gear units and the drive wheels. Alternatively, circular rubber tires may be driven or an endless belt may be driven.

The cleaner mechanism included in the self-propelled cleaner 10 in accordance with the present invention includes the two side brushes 16 (see FIG. 2) disposed on the bottom of the body BD, the main brush 15 (see FIG. 2) disposed in the center part of the bottom of the body BD, and a suction fan that is placed in the dust box 90 and that sucks dust and dirt gathered by the main brush 15. The main brush 15 is driven by the main brush motor 52, and the suction fan is driven by a suction motor 55. Driving power is fed from the motor drivers 54 and 56 to the main brush motor 52 and suction motor 55 respectively. The CPU 21 controls cleaning to be performed using the main brush 15 in consideration of the condition of a floor surface and the condition of the battery or in response to a user's instruction.

The body BD includes a wireless LAN module 61. The CPU 21 can communicate with outside by radio over an external LAN according to a predetermined protocol. The wireless LAN module 61 works on condition that an access point that is not shown is included. The access point shall have an environment permitting connection to an external wide-area network (for example, the Internet) via a router or the like. Therefore, ordinary e-mail messages can be transmitted or received over the Internet or Web sites can be accessed. The wireless LAN module 61 includes a standardized card slot and a standardized wireless LAN card or the like loaded in the slot. Any other standardized card may be loaded in the card slot.

The body BD includes the infrared CCD sensor 73 and an infrared ray source 72. An image signal produced by the infrared CCD sensor 73 is transmitted to the CPU 21 over the bus 24, and the CPU 21 performs various pieces of processing on the image signal. The infrared CCD sensor 73 includes an optical system capable of imaging a forward scene, and produces an electric signal according to infrared light received from a field of view offered by the optical system. Specifically, numerous photodiodes are arranged in association with pixels at the position of the image plane of the optical system. Each of the photodiodes produces an electric signal proportional to electric energy exerted by an infrared ray received thereby. A CCD temporarily stores the electric signal produced to represent each pixel, and produces an image signal composed of successive electric signals representing each pixel. The produced image signal is transmitted to the CPU 21.

Herein, the infrared CCD sensor 73 serves as an imaging sensor that utilizes a change in infrared light incident on the infrared CCD sensor 73. The imaging sensor is not limited to the infrared CCD sensor. For example, if the throughput of the CPU 21 is improved, a construction that produces a color image, searches an area painted in a flesh color characteristic of a human body, and senses a suspicious person on the basis of the size of the flesh-color area and a change in the flesh-color area. Needless to say, a CMOS may be substituted for the CCD. If the large throughput of the CPU 21 is demanded, an image arithmetic device dedicated to image processing to be performed on an image signal may be additionally included. Otherwise, a VRAM may be included in addition to the RAM 22. Since the image signal can be transmitted over the bus 24 included in the body BD, the image arithmetic device and VRAM should merely be interconnected over the bus 24 included in the BD.

(3) Actions to be Performed in the Self-propelled Cleaner

Next, actions to be performed in the self-propelled cleaner 10 in accordance with the present invention will be described below.

The self-propelled cleaner 10 in accordance with the present invention supports (A) an automatic cleaning mode, (B) a navigation mode, and (C) a monitoring mode. A user can change the modes or select any of the modes. The three modes will be briefed below.

(A) Automatic Cleaning Mode

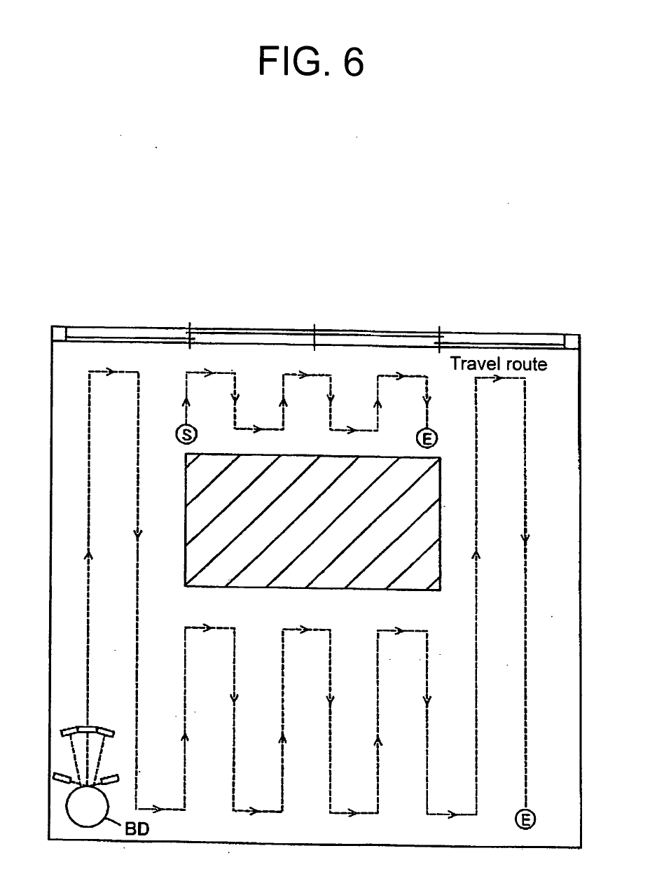

When the automatic cleaning mode is designated, the self-propelled cleaner 10 autonomously travels to perform cleaning according to any of control programs stored in advance in the ROM 23. While the self-propelled cleaner 10 is traveling, if a wall or the irregularities on a floor surface are detected by the sensors, the traveling is controlled according to a control program. The automatic cleaning mode will be described later in conjunction with the drawings (FIG. 5 and FIG. 6).

(B) Navigation Mode

When the navigation mode is designated, the self-propelled cleaner 10 moves to the vicinity of a position at which infrared light is irradiated from a remote controller serving as a light emitting device, and cleans up spot by spot around the position of irradiation. In other words, in the navigation mode, unlike in the automatic cleaning mode, the self-propelled cleaner 10 does not clean up while autonomously traveling. A user uses the remote controller to indicate a place where he/she wants the self-propelled cleaner 10 to clean up and to navigate the self-propelled cleaner 10 to the place for cleaning.

(C) Monitoring Mode

When the monitoring mode is designated, the self-propelled cleaner 10 monitors invasion of a suspicious person. Specifically, the pyroelectric sensors 35 shown in FIG. 2 and the infrared CCD sensor 73 are used to monitor invasion of a suspicious person. When a suspicious person is sensed, a warning signal is transmitted to outside via the wireless LAN module 61.

Referring to the flowchart of FIG. 4, the flow of a main process to be executed in the self-propelled cleaner 10 shown in FIG. 1 to FIG. 3 will be described below. First, at step S100, initialization is performed. Namely, registers included in the CPU 21 are initialized and the RAM 22 is cleared.

At step S110, an instruction with which a mode is selected is checked to see if it is entered. Specifically, an instruction with which any of the three modes (automatic cleaning mode, navigation mode, and monitoring mode) is selected is checked to see if it is entered. If selection of the automatic cleaning mode is recognized at step S110, the automatic cleaning mode is executed at step S120. Execution of the automatic cleaning mode will be described later in conjunction with FIG. 5. If selection of the navigation mode is recognized at step S110, the navigation mode is executed at step S130. If selection of the monitoring mode is recognized at step S110, the monitoring mode is executed at step S140.

Step S120, step S130, or step S140 is executed. Otherwise, if an instruction with which a mode is selected is not recognized at step S110, an instruction with which the power supply of the self-propelled cleaner 10 is turned off is checked to see if it is entered. If the instruction with which the power supply of the self-propelled cleaner 10 is turned off is not entered, processing is returned to step S110. If the instruction is entered, the main process is terminated.

Next, automatic cleaning to be invoked and executed at step S120 in the flow described in FIG. 4 will be described in conjunction with FIG. 5 and FIG. 6. FIG. 5 is a flowchart describing the flow of an automatic cleaning mode, and FIG. 6 illustratively shows an example of a travel route to be traced by the self-propelled cleaner 10 during execution of the automatic cleaning mode. First, at step S200, the body BD is allowed to travel for cleaning. During the processing of step S00, the drive wheel motors 42R and 4L are driven so that the body BD will be rectilinearly traveled. Meanwhile, driving forces are controlled based on the results of sensing performed by various sensors included in the self-propelled cleaner 10. Furthermore, the main brush motor 52 and suction motor 55 are driven so that the body BD will perform cleaning work. Moreover, when a change in an azimuth in which the body BD is oriented and which is detected by the gyro-sensor 37 is sensed, the driving force exerted by the drive wheel motor 42R or 42L is controlled in order to correct the direction of movement of the body BD. Thus, the body BD is kept traveling rectilinearly.

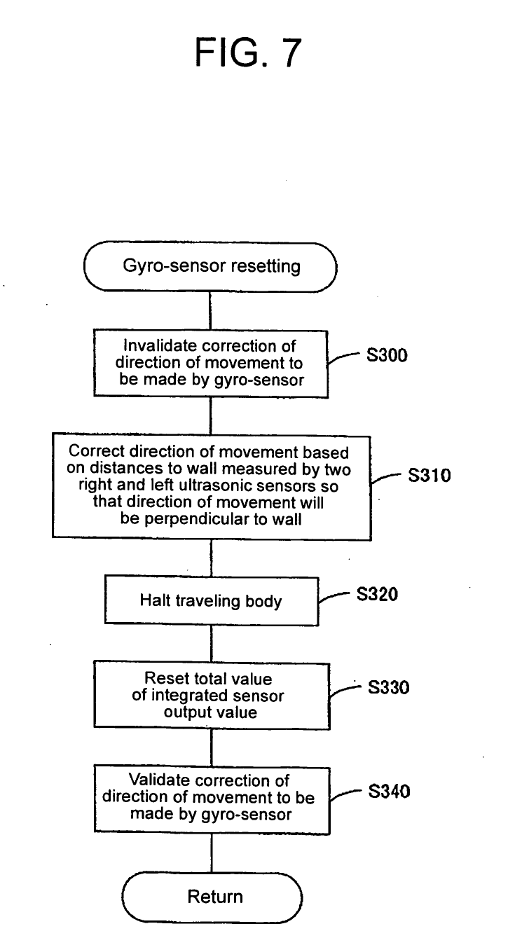

After the processing of step S200 has been executed, whether a forward wall is sensed is verified at step S210. Specifically, whether the ultrasonic sensors 31 have sensed a wall located in the direction of movement of the body BD is verified. If a forward wall is recognized to be sensed at step S210, gyro-sensor resetting is executed at step S220. The processing of step S220 will be described in conjunction with a drawing (FIG. 7) later. Traveling is controlled based on the distances to a wall measured by the two ultrasonic sensors 31 so that the direction of movement of the body BD will be perpendicular to the wall. When the direction of movement becomes perpendicular to the wall, the body BD is halted. Moreover, the total value of a sensor output value integrated by the gyro-sensor 37 is reset. Thus, an azimuth indicated by the gyro-sensor 37 is reset with a direction perpendicular to the wall regarded as a reference direction.

After the processing of step S220 has been executed, the body BD is rotated 90° at step S230. After this processing has been performed, the body BD travels parallel to the wall. For example, after the body BD has started traveling for cleaning at a cleaning start position shown in FIG. 6, when an upward wall is sensed, the body BD is turned right 90°. After the processing of step S230 has been executed, the body travels along the wall at step S240. During the processing, the main brush motor 52 and suction motor 55 are driven in order to perform cleaning work. The gyro-sensor 37 is used to control the direction of movement so that the body will travel along the wall. Thus, the body travels for cleaning. After the body has traveled along the wall over a predetermined distance at step S240, the body BD is turned 90° again at step S250. Referring to FIG. 6, after the body BD has traveled along the upward wall over a predetermined distance, the body BD is turned right 90° again. Consequently, the body BD travels perpendicularly to the wall and recedes from the wall.

After the processing of step S250 has been executed or if no wall is recognized at step S210, the remaining battery capacity of the battery 27 is checked to see if it has decreased. During the processing, the remaining battery capacity of the battery 27 sensed by the battery monitoring circuit 26 is checked to see if it falls below a predetermined reference value. If the remaining battery capacity of the battery 27 is recognized to have decreased at step S260, automatic charging is executed at step S270. The processing is achieved by moving the body BD to the charging device 100 attached to a predetermined wall of a room to be cleaned. Thereafter, the charging terminal 27a of the body BD is coupled to the electrical supply terminal 101 of the charging device 100.

After the processing of step S270 has been executed or if the remaining battery capacity is not recognized to have decreased at step S260, an instruction with which cleaning work is terminated is checked at step S280 to see if it is entered. If the instruction is not recognized to have been entered, processing is returned to step S200. If the instruction is recognized to have been entered, the automatic cleaning mode is terminated.

Next, gyro-sensor resetting to be invoked and executed at step S220 in the flow described in FIG. 5 will be described below. FIG. 7 describes the flow of gyro-sensor resetting to be invoked and executed in step S220 in the flow described in FIG. 5. First, at step S300, correction of the direction of movement to be made by the gyro-sensor 37 is invalidated. Namely, even if the gyro-sensor 37 senses a change in an azimuth, the direction of movement of the body BD will not be corrected.

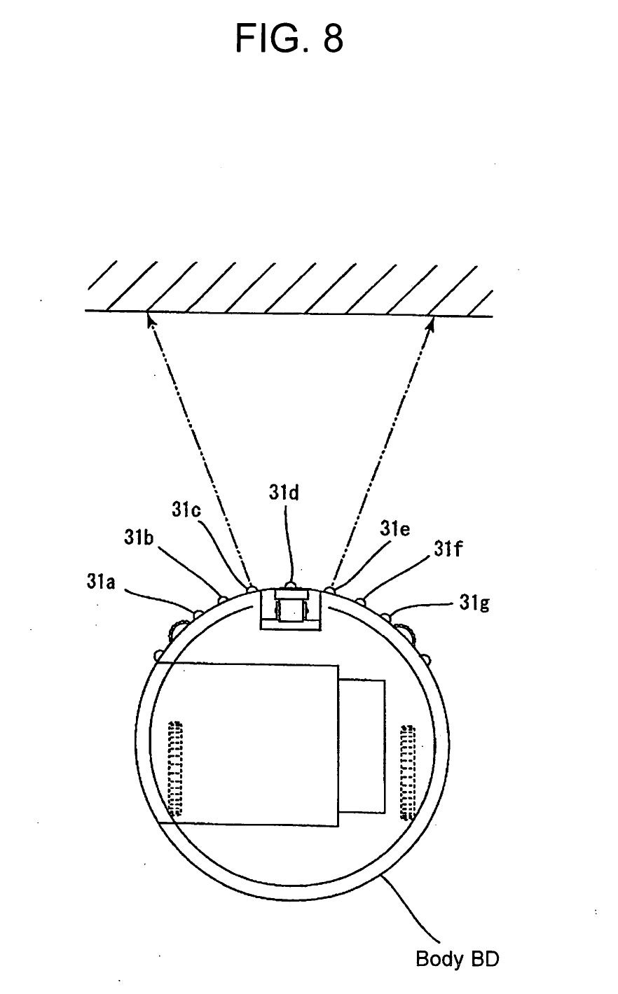

Thereafter, at step S310, the direction of movement is corrected based on the distances to the wall measured by the right and left ultrasonic sensors 31 so that the direction of movement will be perpendicular to the wall. Specifically, for example, as shown in FIG. 8, among the seven ultrasonic sensors 31 (31a to 31g) disposed on the body BD, the ultrasonic sensors 31c and 31e disposed laterally symmetrically with respect to the direction of movement of the body BD are used to measure the distances to a forward wall. The driving forces to be exerted by the drive wheel motors 42R and 42L are then controlled so that the distances measured by the two ultrasonic sensors will become equal to each other. Referring to FIG. 8, the two ultrasonic sensors 31 disposed laterally symmetrically with respect to the direction of movement of the body BD are employed. The present invention is not limited to the two ultrasonic sensors. Alternatively, two ultrasonic sensors that are not disposed laterally symmetrically may be used to correct the direction of movement of the body BD. Moreover, three or more ultrasonic sensors may be used to correct the direction of movement of the body BD. Moreover, referring to FIG. 8, directions of irradiation in which the ultrasonic sensors 31c and 31e irradiate ultrasonic waves meet at an angle. Alternatively, needless to say, the directions of irradiation may be parallel to each other.

Thereafter, at step S320, the body BD is halted. Namely, both the drive wheel motors 42R and 42L are halted at the timing that the direction of movement of the body BD becomes perpendicular to the wall during the processing of step S310. Thus, the body BD is halted. After the processing of step S320 has been executed, the total value of a sensor output value integrated by the gyro-sensor 37 is reset. Owing to this processing, an azimuth permitting the body BD to lie perpendicularly to the wall is regarded to indicate a reference direction.

After the processing of step S330 has been executed, correction of a direction of movement to be made by the gyro-sensor 37 invalidated at step S300 is validated at step S340. Gyro-sensor resetting is then terminated. After the processing of step S340 have been performed, if the gyro-sensor 37 senses a change in the direction of movement in which the body BD is traveling, the driving force exerted by the drive wheel motor 42R or 42L is controlled in order to compensate the change.

As described in conjunction with FIG. 7, as far as the self-propelled cleaner 10 in accordance with the present invention is concerned, every time the body BD approaches a wall, the gyro-sensor 37 is reset to regard a direction perpendicular to the wall as a reference direction. Consequently, an error caused by the gyro-sensor due to a drift phenomenon or the like can be compensated every time the error occurs. Thus, stable traveling can be realized. Moreover, since the ultrasonic sensors 31 designed to prevent collision with a forward wall can be used as sensors for compensating an error caused by the gyro-sensor 37. Eventually, the number of components can be decreased, and a cost of manufacture can be reduced.

(4) Various Variants

In the aforesaid embodiment, an imaging sensor is realized with an infrared CCD sensor. However, the imaging sensor employed in the self-propelled cleaner in accordance with the present invention is not limited to the infrared CCD sensor. Alternatively, for example, a camera that is sensitive to predetermined color light (for example, blue light) will do. In this case, a device that generates the predetermined color light (for example, a blue LED lamp) is adopted as the light emitting device.

In the aforesaid embodiment, assuming that the automatic cleaning mode is designated, every time a forward wall is sensed by the ultrasonic sensors 31, an azimuth indicated by the gyro-sensor 37 is reset. The timing of resetting the azimuth is not limited to any specific timing. The resetting may be performed at regular intervals (for example, at intervals of 2 min) or performed in response to a user's instruction.

As described so far, as far as the self-propelled cleaner 10 in accordance with the embodiment is concerned, when a forward wall is sensed by the ultrasonic sensors 31, the direction of movement of the body BD is corrected to be perpendicular to the wall according to the distances to the wall measured by two ultrasonic sensors. Thereafter, an azimuth indicated by the gyro-sensor 37 is reset with a direction perpendicular to the wall regarded as a reference direction. The ultrasonic sensors 31 designed to prevent collision with the forward wall are used as sensors for compensating an error caused by the gyro-sensor 37. This leads to a decrease in the number of components. Eventually, a cost of manufacture is reduced.

What is claimed is:

1. A self-propelled cleaner comprising a body that includes a cleaner mechanism, a drive mechanism responsible for steering and driving, an angular velocity sensor, an angle detector that detects an azimuth, in which the body is oriented, by integrating a sensor output value detected by the angular velocity sensor, and a plurality of ultrasonic sensors that measures the distance to a wall located in the direction of movement in which the body is moved, wherein:
every time the wall enters a range of distance measurement within which the ultrasonic sensors measure distances, every time a certain time elapses, or every time a user enters an instruction, control of a driving force which the drive mechanism exerts according to the azimuth detected by the angle detector is invalidated based on the distances to the wall measured by at least two ultrasonic sensors;
the drive mechanism is controlled based on the distances to the wall measured by at least two ultrasonic sensors so that the self-propelled cleaner will travel toward the wall and the direction of movement of the body will be perpendicular to the wall;
when the direction of movement of the body becomes perpendicular to the wall, the body is halted, and the total value of a sensor output value integrated by the angle detector is reset; and
control of the driving force which the drive mechanism exerts according to the azimuth detected by the angle detector is then validated.

2. A self-propelled cleaner comprising a body that includes a cleaner mechanism, a drive mechanism responsible for steering and driving, an angular velocity sensor, an angle detector that detects an azimuth, in which the body is oriented, by integrating a sensor output value detected by the angular velocity sensor, and a plurality of distance meters that measures the distance to a wall located in the direction of movement in which the body is moved, further comprising a reset processor that:
controls the drive mechanism on the basis of the distances to the wall measured by at least two distance meters so that the direction of movement of the body will meet the wall at a predetermined angle; and
when the direction of movement of the body has come to meet the wall at the predetermined angle, halts the body, and then resets the total value of a sensor output value integrated by the angle detector.

3. The self-propelled cleaner according to claim 2, wherein:
the reset processor controls the drive mechanism on the basis of the distances to the wall measured by at least two distance meters so that the direction of movement of the body will be perpendicular to the wall; and
when the direction of movement of the body becomes perpendicular to the wall, the reset processor halts the body and then resets the total value of a sensor output value integrated by the angle detector.

4. The self-propelled cleaner according to claim 3, wherein:
the reset processor invalidates control of a driving force which the drive mechanism exerts according to the azimuth detected by the angle detector;
the reset processor controls the drive mechanism on the basis of the distances to the wall measured by at least two distance meters so that the self-propelled cleaner will travel toward the wall and the direction of movement of the body will be perpendicular to the wall;
when the direction of movement of the body becomes perpendicular to the wall, the reset processor halts the body; and
the reset processor resets the total value of a sensor output value integrated by the angle detector, and then validates control of the driving force which the drive mechanism exerts according to the azimuth detected by the angle detector.

5. The self-propelled cleaner according to claim 2, wherein: the distance meter is realized with an ultrasonic sensor.

6. The self-propelled cleaner according to claim 2, wherein the reset processor resets the total value of a sensor output value every time the wall enters a range of distance measurement within which the distance meters measure the distances to the wall.

7. The self-propelled cleaner according to claim 2, wherein the reset processor resets the total value of a sensor output value every time a certain time elapses.

8. The self-propelled cleaner according to claim 2, wherein the reset processor resets the total value of a sensor output value every time a user enters an instruction.

9. The self-propelled cleaner according to claim 2, wherein: the body has a substantially cylindrical shape; and when two drive wheels disposed on the bottom of the body are driven independently of each other, the drive mechanism can rectilinearly advance, withdraw, or turn the body.

10. The self-propelled cleaner according to claim 5, wherein:
the ultrasonic sensor includes a generator that generates ultrasonic waves, and a receiver that receives ultrasonic waves generated by the generator and reflected from a forward wall, and calculates the distance to the wall on the basis of a time elapsing until ultrasonic waves generated by the generator are received by the receiver; and
seven ultrasonic sensors are included as the distance meters.

11. The self-propelled cleaner according to claim 9, wherein:
the drive mechanism includes motor drivers, drive wheel motors, and gear units interposed between the drive wheel motors and the drive wheels; and
when the body is turned, the motor drivers finely control a direction of rotation and an angle of rotation so as to drive the drive wheel motors respectively.

12. The self-propelled cleaner according to claim 11, further comprising rotary encoders included as integral parts of the respective drive wheel motors, wherein the actual directions of rotation and the actual angles of rotation in and at which the drive wheels are rotated are accurately sensed based on outputs of the respective rotary encoders.

13. The self-propelled cleaner according to claim 2, wherein the angle detector includes a gyro-sensor as an angle sensor.

14. The self-propelled cleaner according to claim 13, wherein the reset processor first invalidates correction of a direction of movement to be made by the gyro-sensor, resets the total value of an integrated output value, and then validates the correction of the direction of movement to be made by the gyro-sensor so as to terminate gyro-sensor resetting.

15. The self-propelled cleaner according to claim 5, wherein the reset processor corrects the direction of movement on the basis of the distances to the wall measured by two right and left ultrasonic sensors so that the direction of movement will be perpendicular to the wall.

16. The self-propelled cleaner according to claim 11, wherein:
the distance meters include a plurality of ultrasonic sensors disposed on the body;
the reset processor uses two ultrasonic sensors, which are disposed laterally symmetrically with respect to the direction of movement of the body, among the plurality of ultrasonic sensors to measure distances to a forward wall; and
the reset processor controls the driving forces exerted by right and left drive wheel motors so that the distances to the wall measured by the two ultrasonic sensors will be equal to each other.

17. The self-propelled cleaner according to claim 5, wherein the reset processor uses two ultrasonic sensors, which are not laterally symmetrical, to correct the direction of movement of the body, or uses three or more ultrasonic sensors to correct the direction of movement of the body.

18. The self-propelled cleaner according to claim 16, wherein the reset processor halts both the drive wheel motors so as to halt the body at the timing that the direction of movement of the body becomes perpendicular to the wall.
